(19) United States
(12) Patent Application Publication
(10) Pub. No.: US 2024/0360386 A1
(43) Pub. Date: Oct. 31, 2024

(54) FOAM-RICH INSTANT CLEANING BLOCK AND METHOD THEREFOR

(71) Applicant: Cosbe Laboratory Inc., Shantou (CN)

(72) Inventors: ZEHUA ZHAO, Shantou (CN); SONGWU ZHENG, Shantou (CN); XIAOFAN CHEN, Shantou (CN); SHANZHAO ZHUANG, Shantou (CN)

(73) Assignee: Cosbe Laboratory Inc., Shantou (CN)

(21) Appl. No.: 18/764,599

(22) Filed: Jul. 5, 2024

Related U.S. Application Data
(63) Continuation of application No. PCT/CN2022/073925, filed on Jan. 26, 2022.

(30) Foreign Application Priority Data
Jan. 5, 2022 (CN) 2022100135291

(51) Int. Cl. C11D 3/00; C11D 1/28; C11D 3/04; C11D 3/10; C11D 3/20; C11D 3/22; C11D 3/32; C11D 3/40; C11D 3/50; C11D 17/00

(52) U.S. Cl. CPC C11D 3/0094; C11D 1/28; C11D 3/0047; C11D 3/042; C11D 3/046; C11D 3/10; C11D 3/2079; C11D 3/225; C11D 3/323; C11D 3/40; C11D 3/50; C11D 17/0052; C11D 2111/48

(57) ABSTRACT

A foam-rich instant cleaning block, which is calculated according to parts by weight from: 15-25 parts of an alkaline salt; 15-20 parts of a pH buffer regulator; 5-8 parts sodium lauryl sulfate; 28-30 parts sodium lauroyl glutamate; 20-25 parts of a filler; 0.3-0.5 parts sodium carboxymethyl cellulose; 1-2.5 parts of a preservative, 0-0.5 part of a fragrance, and 0-0.1 parts of a pigment. The foam-rich instant cleaning block is a solid block composition which has evenly distributed components, a density of 1.1-1.25 g/cm³, and a compressive strength of 130-180 N/cm². The product has a simple fabrication process, is convenient to use, and various packaging modes therefor have a preservation effect. The product has a high proportion of cleaning ingredients, and dissolved bath liquid may produce rich and stable foam.

### CROSS-REFERENCE TO RELATED APPLICATIONS

The application claims priority to Chinese patent application No. 2022100135291, filed on Jan. 5, 2022, the entire contents of which are incorporated herein by reference.

### TECHNICAL FIELD

This invention relates to the technical field of cleaning products, specifically involving a foam-rich instant cleaning block, as well as its preparation method, packaging method, and usage method.

### BACKGROUND

Currently, in the cleaning product market, liquid-based formulations in cleaning products are widely used due to their convenience of on-the-go use, making them the most common choice across various scenarios. However, given the ongoing global normalization of pandemics, consumers increasingly demand portable personal hygiene products, particularly while traveling. Liquid formulations face challenges related to the size constraints of their packaging containers, which creates a conflict between portability and volume capacity. Additionally, carrying small pouches of liquid cleaning products poses a risk of pouch damage and potential contamination of other items.

Recently, a type of instant-dissolving solid cleaning formulation has emerged on the market, such as the 20-30s rapid-dissolving soap disclosed in CN202110792122.9. When using such products, users simply rub the rapid-dissolving soap between their hands, allowing it to dissolve quickly in water to form a foamy liquid hand cleanser for use. This product is portable and with the characteristic of being used as needed in a reasonable manner, overcoming the portability and volume capacity conflicts inherent in liquid-based cleaning formulations.

The development goal of this product primarily focuses on hand hygiene. Therefore, its design direction emphasizes improving the product's efficiency in rapid dissolution and initial cleaning efficacy. However, using the hand cleanser formed after the product dissolves directly as a body wash for large-scale overall body cleaning presents the following inappropriate aspects:
(1) Manufacturing process is not easy: To avoid the drawbacks of product moisture absorption, there are currently two advantageous methods: using soluble film to wrap the surface of rapid-dissolving soap to isolate moisture from the air, or separately using baking soda/citric acid and the remaining ingredients to create the first and second pieces, which are then nested together to form a cleaning block, reducing the contact surface between the two gas generating agents. However, both methods have certain drawbacks in their manufacturing and usage processes: The former method may result in visual discomfort for users due to the slow dissolution of the soluble film during use, leading to visually perceived film fragments resembling suspended particles in the cleaning solution; The latter method requires ensuring that the first and second pieces have sufficient strength during production to avoid the risk of piece breakage during nesting, and this manufacturing approach typically results in a relatively lower yield of high-quality products;
(2) low content of cleaning ingredients: In such products, the surfactants used for cleaning typically comprise only 1% to 3% of the total content, which is very low. As a result, the foam generated has a short duration, making it suitable for quick hand cleaning but not ideal for extensive body cleansing;
(3) Packaging options are limited: To ensure that each product unit contains sufficient surfactant content for effective cleaning, and to facilitate consumer use through rubbing and kneading, some products are shaped like mahjong tiles. Due to their larger size and the need to isolate them from air, these products are often individually packaged in three-sided sealed bags. However, this packaging method also contributes to increased plastic waste, which contradicts current environmental efforts to reduce plastic product usage;
(4) Storage is quite challenging: This product is constrained by its three-sided sealed plastic bag packaging, which has relatively poor air tightness. Additionally, because the product uses a high proportion of baking soda/citric acid as air generating agents, these ingredients are hygroscopic. The high proportion of air generating agents (total content 55%-80%) increases the likelihood of moisture absorption. Furthermore, over extended storage periods, if moisture absorption causes the product to become damp, the materials used as air generating agents may undergo neutralization reactions, leading to potential product disintegration. As a result, it becomes challenging to maintain the product's structural integrity, resulting in a relatively short shelf life for the product.

### SUMMARY

To provide consumers with a portable personal hygiene product suitable for whole-body cleansing, the applicant has developed a foam-rich instant cleaning block. This product contains a high proportion of surfactant ingredients that can dissolve in water in a suitable time to form a rich and dense foam, creating a liquid bath cleanser. While delivering effective cleansing, the product is mildly acid and characterized by its amino acid-based surfactants as the primary cleaning agents, which are gentle on the skin and non-irritating.

To achieve the above objectives, the present invention is implemented through the following technical means:

a foam-rich instant cleaning block, characterized by being composed, by weight parts, of the following components:

Alkaline salt 15-25 parts; pH buffer regulator 15-20 parts; sodium lauryl sulfate 5-8 parts; sodium lauroyl glutamate 28-30 parts; filler 20-25 parts; sodium carboxymethyl cellulose 0.3-0.5 parts; preservative 1-2.5 parts; fragrance 0-0.5 parts; pigment 0-0.1 parts

The cleaning block described is a solid block-shaped composition with the components uniformly distributed, having a density of 1.1-1.25 g/cm³ and compressive strength of 130-180 N/cm².

The alkaline salts mentioned include sodium carbonate, potassium carbonate, sodium bicarbonate (baking soda), potassium bicarbonate, or a combination thereof.

The pH buffering agents mentioned include citric acid, tartaric acid, sodium citrate, or a combination thereof.

The fillers mentioned include magnesium sulfate, sodium sulfate, urea, or a combination thereof.

The invention also provides a method for manufacturing the aforementioned foam-rich instant cleaning block. This method enables the convenient and stable production of the cleaning block with rich foam. Specifically, it is achieved through the following steps:
(1) Add powdered alkaline salts, sodium lauryl sulfate, sodium lauroyl glutamate, filler, sodium carboxymethyl cellulose, preservative, fragrance, and pigment in specified proportions into a disperser. Stir the mixture thoroughly at room temperature until it is well dispersed, forming powder mixture A;
(2) Add the powdered pH buffer regulator in specified proportions into a grinder. Stir and grind the mixture at room temperature, then sieve it to obtain pH buffer regulator with a particle size of 80-100 mesh;
(3) Add the 80-100 mesh pH buffer regulator into the powder mixture A and mix them together. Stir at a speed of 1000-1500 r/min for 30-60 seconds. Repeat this process 2-3 times to create powder mixture B.
(4) Pack the powder mixture B into molds. Use a compression molding machine with a pressure of 5-15 kg/cm² of unit area to press the powder mixture B. Maintain the pressure for 1-5 seconds before demolding to produce pre-formed blocks;
(5) Transfer the pre-formed blocks to a drying room and dry them under conditions of 25-28° C. temperature and 30%-40% relative humidity (RH) for 24 hours. This process results in the foam-rich instant cleaning blocks as described.

The invention also provides a method for packaging the aforementioned foam-rich instant cleaning blocks. By forming the cleaning blocks into solid shapes and individually storing them in three-sided sealed bags or aluminum-plastic blister packaging, stable preservation effects can be achieved.

The invention also provides a method for using the aforementioned foam-rich instant cleaning blocks. This method enables the pumping out of a rich and dense foam to form a liquid bath cleanser, offering convenient usage. Here are the steps for using it:
(1) Dissolve the cleaning block in water to form a cleanser, using 8% to 15% by weight percentage of the cleaning block;
(2) Pump the cleanser out of the container directly or after agitation using a foam pump head.

This invention simultaneously possesses the following beneficial aspects:
1. High content of cleaning agents, stable and long shelf life: Compared to fast-dissolving soaps, this product achieves a rational reduction in the proportion of alkaline salts and pH buffering agents used as air generating agents (approximately 27%-50%), while significantly increasing the proportion of surfactants such as sodium lauryl sulfate and sodium lauroyl glutamate (approximately 30%-45%). This formulation reduces the product's hygroscopic nature, preventing potential degradation due to neutralization reactions caused by high levels of moisture-absorbing air generating agent materials;
2. Simple and effective manufacturing, packaging, and storage processes: By rationally reducing the proportion of air generating agent materials, reducing the need for alkaline salts and pH buffering agents, eliminating the requirement for additional soluble water-soluble films and high-pressure equipment to compress into high-strength blocks to prevent disintegration; meanwhile, the high proportion of surfactants ensures sufficient cleaning power. When produced in small block forms for commercialization, they already contain adequate surfactant content. Packaging processes can be efficiently completed using standard small three-side sealed packaging or small aluminum-plastic blister packaging equipment, effectively reducing production equipment costs. The compact commercial form allows effective airtight packaging whether using small three-side sealed bags or more airtight aluminum-plastic blister packaging. The shelf life of this foam-rich instant cleaning block can reach 3-5 years;
3. The formulation is suitable for shower cleaning: the process is simple, involving water solubility and agitation to quickly break down the instant cleaning block into fragments. This effectively increases the contact between the fragmented instant cleaning block material and water, promoting rapid foam generation and enhancing dissolution. The resulting shower cleaning solution exhibits a slightly acidic pH similar to human skin and contains a higher proportion of amino acid-based surfactant sodium lauroyl glutamate, making the overall formulation gentler on the skin.

### DETAILED DESCRIPTION OF THE EMBODIMENTS

To ensure that the technical means, creative features, objectives, and effects achieved by this invention are easily understood, the following, in conjunction with specific implementation methods, further elaborates on this invention.

### Implementation Example (IE)

The raw materials are proportioned according to the weight fraction ratios in IE 1-8, as shown in Table 1:

TABLE 1
Proportion Table for Ingredients of Rich Foam Instant Dissolving Cleaning Blocks, IE 1-8

| Components | | IE 1 | IE 2 | IE 3 | IE 4 | IE 5 | IE 6 | IE 7 | IE 8 |
|---|---|---|---|---|---|---|---|---|---|
| Alkaline salt | Sodium carbonate | 15 | — | 2 | — | — | 5 | — | — |
| | Potassium carbonate | | 6 | 18 | — | 23.8 | 2 | — | — |
| | Sodium bicarbonate | — | 5 | 2.6 | 20 | — | 8 | — | 24 |
| | Potassium bicarbonate | — | 7.5 | — | — | — | 7 | 16.8 | — |
| pH buffer | Citric acid | — | 5 | — | 17.2 | — | 15.5 | 2.5 | — |
| regulator | Tartaric acid | 20 | 8 | 18 | — | — | — | 6 | — |
| | Sodium citric | — | 3 | — | — | 16 | — | 9 | 20 |
| Filler | Magnesium sulfate | 6 | 7 | — | — | 10 | 8 | — | 2 |
| | Sodium sulfate | 10 | 14 | 20 | — | — | 10 | 20 | 18 |
| | Urea | 5 | — | — | 25 | 13 | 5 | — | 2 |
| Surfactant | Sodium lauryl sulfate | 6 | 8 | 7 | 5 | 8 | 6 | 5 | 7 |
| | Sodium lauroyl glutamate | 28 | 28 | 28 | 30 | 30 | 29 | 29 | 29 |
| Adhesive | Sodium carboxymethyl | 0.3 | 0.3 | 0.3 | 0.5 | 0.5 | 0.4 | 0.4 | 0.4 |
| | cellulose | | | | | | | | |
| Preservative | Sodium benzoate | 1.2 | 1.2 | 1.6 | 1.5 | 2.3 | 2.1 | 1 | 1.5 |
| Fragrance | Lemon essence | 0.3 | 0.3 | 0.45 | 0.45 | 0.28 | 0.28 | — | — |
| Pigment | Lemon yellow | 0.1 | — | 0.08 | 0.05 | 0.02 | 0.02 | — | — |

To manufacture the foam-rich instant cleaning block according to the weight fraction ratios in Table 1, follow the preparation method outlined below:
(1) Powdered alkaline salts, sodium lauryl sulfate, sodium lauroyl glutamate, fillers, sodium carboxymethyl cellulose, preservatives, fragrance, and pigment from IE 1-8 are added according to the weight fraction ratios into a disperser equipped with a cooling jacket. They are stirred and dispersed at room temperature, with a stirring speed of 2500-3000 r/min for 1-2 minutes to ensure thorough dispersion of each component, forming powder mixture A;
(2) Add the pH buffer regulator into a grinder according to the weight fraction ratios, stir and grind at room temperature, sift to obtain pH buffer regulator with a particle size of 80-100 mesh;
(3) Add the 80-100 mesh pH buffer regulator into the powder mixture A, mix them together, and stir at a speed of 1000-1500 r/min for 30-60 seconds. Repeat this process 2-3 times to produce powder mixture B;
(4) Take the powder mixture B and load it into molds. Use a forging press machine to apply pressure at a rate of 5-15 kg/cm² of surface area onto the powder mixture B. Maintain this pressure for 1-5 seconds before demolding to produce pre-formed blocks;
(5) Transfer the pre-formed blocks to a drying room and dry them under conditions of 25-28° C. temperature and 30%-40% relative humidity (RH) for 24 hours. This process yields the foam-rich instant cleaning blocks as described.

Through the preparation method described above, samples of foam-rich instant cleaning blocks from Examples 1-8, as well as commercially available 20s-30s quick-dissolving soap samples (used as Comparison Example (CE) 1), and samples prepared using the formulation and preparation method of CN202110792122.9 Example 6 (used as CE 2), are subjected to the following density and compressive strength testings:

### Density Testing:

Perform density tests on the foam-rich instant cleaning blocks prepared in Examples 1-8. The experimental instrument is a 200 ml graduated cylinder (calibrated by Shenzhen Dafeng Measurement). The testing method involves measuring 100 grams of white mineral oil into the cylinder, recording the scale data, then placing the known weight sample into it and recording the scale data after insertion to determine the volume, thus calculating the density data. Detailed test results are shown in Table 2.

TABLE 2
Density testing result table

| Testing items | IE 1 | IE 2 | IE 3 | IE 4 | IE 5 | IE 6 | IE 7 | IE 8 | CE 1 | CE 2 |
|---|---|---|---|---|---|---|---|---|---|---|
| Density (g/cm²) | 1.18 | 1.21 | 1.24 | 1.24 | 1.23 | 1.18 | 1.21 | 1.20 | 1.29 | 1.31 |

The density test results above show that the foam-rich instant cleaning blocks prepared by the formulation of the present invention have a density range between 1.18-1.24 g/cm³. The density of CE 1 is 1.29 g/cm³, and the density of CE 2 is 1.31 g/cm³.

### Compressive Strength Testing:

The foam-rich instant cleaning block samples prepared in IE 1-8 and the CE (commercial 20-30s instant soap samples) were subjected to a compressive strength test. The samples from IE 1-8 and the above-mentioned CE 1 and 2 were pre-processed into small test pieces with a diameter of 3 cm and a height of 1 cm. The compressive strength of the samples from IE 1-8 and the CE 1 and 2 was tested using an Edberg NK-500 pointer push-pull force gauge with an attached flat test head. The flat test head was used to apply pressure to the center of the samples from IE 1-8 and the CE 1 and 2 until cracking occurred. The compressive strength was then measured by dividing the pressure by the area of the flat test head. The higher the measured value, the harder and more resistant to breakage the sample is, indicating better impact resistance during transportation and handling. The detailed test results are shown in Table 3:

TABLE 3
Compressive strength testing result table

| Testing items | IE 1 | IE 2 | IE 3 | IE 4 | IE 5 | IE 6 | IE 7 | IE 8 | CE 1 | CE 2 |
|---|---|---|---|---|---|---|---|---|---|---|
| Compressive | 135 | 162 | 153 | 147 | 176 | 156 | 144 | 139 | 392 | 352 |
| strength (N/cm²) | | | | | | | | | | |

From the above testing data, it can be seen that the compressive strength of the foam-rich instant cleaning block samples in IE 1-8 ranges from 130-180 N/cm². After conducting experiments, the inventors found that during the final commercial manufacturing process, it is feasible to produce small blocks with a diameter of 3 cm and a height of 1 cm. These can be reasonably packaged in three-side sealed bags or aluminum-plastic blister packaging. With this compressive strength, the quick-dissolving cleaning block samples, along with the mentioned packaging methods, can effectively prevent the blocks from crumbling or breaking due to external impacts during transportation;

Under the same commercial conditions, the weight range of the foam-rich instant cleaning block samples with a diameter of 3 cm and a thickness of 1 cm varies. However, the foam-rich instant cleaning block samples contain about 30%-45% by weight of surfactants, whereas the CE contain only 1%-3% of surfactants. The proportion of surfactants with cleaning efficacy in these samples is significantly higher than in the CE. Therefore, under the same cleaning efficiency conditions, this instant cleaning block can be commercialized in a more compact form;

Based on the impact resistance and high proportion of surface cleaning agents in the foam-rich instant cleaning block, it is more advantageous to use aluminum-plastic blister packaging. This type of packaging offers strong airtight properties, which can more effectively isolate the cleaning block from moisture in the external air. Additionally, it enhances the portability and commercial viability of the instant cleaning block.

The samples prepared as described in IE1-8 and CE 1 and 2 were made into small test pieces with a diameter of 3 cm and a height of 1 cm, and dissolved in 100 ml of water. Using the following methods, the dissolution time, foam properties, pH value, and usage effect of the cleaning liquid samples from Examples 1-8 and Comparative Samples 1 and 2 were tested and recorded. The results are as follows:

### Water Dissolution Time Test:

Under two initial water temperature conditions suitable for bathing (55° C.) and boiling water (100° C.), the samples from IE1-8 and CE 1 and 2 were placed in 100 mL of water. They were left to dissolve naturally in a stationary beaker and also agitated in a handheld container by shaking once per second for 30 seconds to simulate an acceptable user method. Afterward, they were poured into a beaker and observed until they completely dissolved naturally. During this process, the time taken for IE 1-8 and CE 1 and 2 to completely dissolve was recorded under these four conditions. The detailed results are shown in Table 4:

Table 4: Water dissolution time test result table

| Testing | | | | | | | | | | | | | | | | | | | | |
|---|---|---|---|---|---|---|---|---|---|---|---|---|---|---|---|---|---|---|---|---|
| items | IE 1 | | IE 2 | | IE 3 | | IE 4 | | IE 5 | | IE 6 | | IE 7 | | IE 8 | | CE 1 | | CE 2 | |
| 55° C. | 37 | min | 36 | min | 35 | min | 38 | min | 38 | min | 36 | min | 38 | min | 34 | min | 40 | min | 37 | min |
| Natural | | | | | | | | | | | | | | | | | | | | |
| Water | | | | | | | | | | | | | | | | | | | | |
| Dissolution | | | | | | | | | | | | | | | | | | | | |
| Time | | | | | | | | | | | | | | | | | | | | |
| 55° C. | 6 | min | 7 | min | 6 | min | 6 | min | 5 | min | 6 | min | 5 | min | 6 | min | 20 | min | 21 | min |
| Agitated | 15 | s | 11 | s | 54 | s | 26 | s | 45 | s | 12 | s | 54 | s | 54 | s | 13 | s | 45 | s |
| Water | | | | | | | | | | | | | | | | | | | | |
| Dissolution | | | | | | | | | | | | | | | | | | | | |
| Time | | | | | | | | | | | | | | | | | | | | |
| 100° C. | 5 | min | 5 | min | 4 | min | 4 | min | 4 | min | 4 | min | 4 | min | 4 | min | 10 | min | 12 | min |
| Natural | 52 | s | 15 | s | 35 | s | 45 | s | 20 | s | 15 | s | 35 | s | 08 | s | 55 | s | 17 | s |
| Water | | | | | | | | | | | | | | | | | | | | |
| Dissolution | | | | | | | | | | | | | | | | | | | | |
| Time | | | | | | | | | | | | | | | | | | | | |
| 100° C. | 2 | min | 2 | min | 3 | min | 3 | min | 3 | min | 3 | min | 3 | min | 3 | min | 9 | min | 10 | min |
| Agitated | 50 | s | 55 | s | 12 | s | 09 | s | 15 | s | 15 | s | 12 | s | 3 | s | 16 | s | 25 | s |
| Water | | | | | | | | | | | | | | | | | | | | |
| Dissolution | | | | | | | | | | | | | | | | | | | | |
| Time | | | | | | | | | | | | | | | | | | | | |

From the above data, it was observed that the samples of IE 1-8 dissolve more slowly than the CE under natural water dissolution conditions at 55° C. However, under agitated water dissolution at 55° C., natural water dissolution at 100° C., and agitated water dissolution at 100° C., the samples of IE 1-8 dissolve more quickly. Additionally, during natural water dissolution at 100° C., there was an observed phenomenon of separation among the samples of IE 1-8 midway through the process. Furthermore, under both 55° C. and 100° C. agitated water dissolution conditions, noticeable fragmentation and separation were observed in the foam-rich instant cleaning block samples of IE1-8. In contrast, CE 1 and 2 remained intact without significant fragmentation or separation under these conditions.

The inventors believe that this validates the lower compressive strength of the foam-rich instant cleaning block samples in IE 1-8 compared to commercially available samples. This characteristic allows the foam-rich instant cleaning block samples in IE 1-8 to naturally separate under high-temperature water dissolution conditions or break apart due to mechanical agitation in oscillating water dissolution conditions. The increased surface contact between the fragmented foam-rich instant cleaning block and water enhances the intensity of neutralization reactions involving alkaline salts as air generating agent and pH buffer regulators. This process promotes a faster dissolution effect for the foam-rich instant cleaning block samples in IE 1-8.

### Foam Property Test:

Take 10 mL of the bath cleaning solution from IE 1-8, CE 1, and 2 after complete dissolution. Place each into a 100 mL transparent bottle equipped with regular shower gel pump heads and foaming mousse pump heads, creating sealed non-pressurized containers. After shaking the container for 10 seconds, pump out foam using the regular shower gel pump head and foaming mousse pump head. Observe the initial appearance of the foam pumped out by both pump heads, the time it takes for the foam volume pumped by the foaming mousse pump head to halve, the time for the foam inside the bottle to visibly recover after shaking, and the foam appearance during the process of directly washing the arm with the shower gel. The detailed results are shown in Table 5:

TABLE 5
Foam property test result table

| Testing item | IE 1 | | IE 2 | | IE 3 | | IE 4 | | IE 5 | | IE 6 | | IE 7 | | IE 8 | | CE 1 | CE 2 |
|---|---|---|---|---|---|---|---|---|---|---|---|---|---|---|---|---|---|---|
| Regular Shower | Fine, dense, continuous foam strips with a small amount attached | | | | | | | | | | | | | | | | A liquid | A liquid |
| Gel Pump Head | to the nozzle | | | | | | | | | | | | | | | | mixture | mixture |
| Initial | | | | | | | | | | | | | | | | | containing | containing |
| Appearance of | | | | | | | | | | | | | | | | | a small | a small |
| Pumped Foam | | | | | | | | | | | | | | | | | amount of | amount |
| | | | | | | | | | | | | | | | | | foam | of foam |
| Foaming | Similar to mousse, it forms fine, dense, continuous foam strips | | | | | | | | | | | | | | | | Foam | Foam |
| Mousse Pump | with a small amount of foamy attached to the nozzle | | | | | | | | | | | | | | | | mixed | mixed |
| Head Initial | | | | | | | | | | | | | | | | | with liquid | with |
| Appearance of | | | | | | | | | | | | | | | | | | liquid |
| Pumped Foam | | | | | | | | | | | | | | | | | | |
| Time for the | 8 | min | 9 | min | 8 | min | 9 | min | 9 | min | 8 | min | 8 | min | 9 | min | 45 s | 39 s |
| Volume of | 10 | s | 15 | s | 20 | s | 18 | s | 10 | s | 23 | s | 45 | s | 10 | s | | |

| Foam Pumped | | | |
|---|---|---|---|
| from Foaming | | | |
| Mousse Pump | | | |
| Head to Halve | | | |
| Time for Foam | 5-6 s | Instantly | Instantly |
| Inside the | | noticeable | noticeable |
| Bottle to Visibly | | shower gel | shower |
| Recover After | | recovery | gel |
| Shaking | | | recovery |

| | | | |
|---|---|---|---|
| Foam | Approximately two-thirds are fine foam bubbles with a diameter | Mostly | Mostly |
| Appearance | of 1 mm, while the remainder consists of foam bubbles with a | foam | foam |
| After the | diameter of approximately 3-5 mm | bubbles | bubbles |
| Volume of | | with a | with a |
| Foam Pumped | | diameter | diameter |
| from Foaming | | of 3-5 mm, | of 3- |
| Mousse Pump | | characterized | 5 mm, |
| Head to Halved | | by | characterized |
| | | unstable | by |
| | | and | unstable |
| | | continuous | and |
| | | bursting | continuous |
| | | | bursting |
| Foam | After friction, it forms fine foam that is 2-3 times larger in | Contains a | Contains |
| Appearance | volume | small | a small |
| During Direct | | amount of | amount |
| Arm Washing | | foam that | of foam |
| with Shower | | forms a | that |
| Gel | | thin layer | forms a |
| | | | thin |
| | | | layer |

From the above test results, it was found that the bath cleanser formed after the dissolution of the foam-rich instant cleaning block samples in IE 1-8 can produce dense and long-lasting foam when agitated, even in non-pressurized containers. The bath cleanser formed under these conditions can achieve the foam structure mentioned above. Therefore, the foaming mousse pump head can adopt a detachable design, such as combining with the bottle through a twist-lock mechanism, to achieve reusable functionality. This effectively reduces environmental plastic pollution and complies with current plastic reduction regulations in various countries;

The bath cleanser formed after the dissolution of the foam-rich instant cleaning block samples contain a rich amount of Sodium Lauroyl Glutamate (amino acid type) and Sodium Lauryl Sulfate (anionic type) in appropriate proportions as surfactants. These components can generate abundant and stable foam during the cleaning process. This formulation is particularly suitable for shower products that require sustained foam to facilitate thorough body cleansing.

### pH Value Test:

Test the pH value of the bath cleanser formed after complete dissolution of IE 1-8 and CEs using a Shanghai Lei-ci pHS-2F pH meter as the testing instrument. The detailed results are shown in Table 6:

TABLE 6
pH value test result table

| Testing item | IE 1 | IE 2 | IE 3 | IE 4 | IE 5 | IE 6 | IE 7 | IE 8 | CE 1 | CE 2 |
|---|---|---|---|---|---|---|---|---|---|---|
| pH value | 5.8 | 6.1 | 6.8 | 6.7 | 5.7 | 5.8 | 5.4 | 6.2 | 8.6 | 8.4 |

The pH value test results above indicate that the bath cleanser from the foam-rich instant cleaning block samples in Example 1-8 shows a pH level close to the mildly acidic environment of normal human skin (the pH on the surface of the neck skin is typically between 4.5-5.5, and pH values on different parts of the body's skin generally range from 4.5-6.5). This pH range helps prevent irritation to human skin during use. In contrast, the comparative samples overall exhibit alkaline tendencies, which may potentially cause some irritation, particularly on more delicate skin, during cleansing.

### Effectiveness Test:

For 30±5-year-old participants, 50 males and 50 females will be allocated into 10 groups, with each group consisting of 5 males and 5 females. Each participant will receive 100 mL of the bath cleanser formed
after complete dissolution of IE 1-8, CE 1, or CE 2 as their test product. Participants will be instructed to use the assigned product to wash one side of their neck skin during bathing. (The neck skin is chosen for its propensity to sweat and accumulate dirt, daily exposure, and relatively delicate nature, making it representative for testing purposes.) The other side of the neck will be cleaned with plain water by rubbing. This regimen will be followed continuously for two weeks.

Using the TM300 from German CK Company as the instrument for testing the transepidermal water loss (TEWL) parameter of the participants' neck skin, and the Shanghai Lei-ci pHS-2F pH meter as the instrument for testing the changes in skin pH of the participants' necks. The testing will be conducted at three time points: the initial state, after the first week of using the test product, and after the second week. Each test will be performed 1.5 hours after the participants have dried their necks post-bathing. The detailed results are shown in Table 7:

TABLE 7
Effectiveness test result table

| | | Initial state | | First week | | Second week | |
|---|---|---|---|---|---|---|---|
| | | Transepidermal | | Transepidermal | | Transepidermal | |
| | | Water Loss | | Water Loss | | Water Loss | |
| Test | Sample | (TEWL) Value | Neck Skin | (TEWL) Value | Neck Skin | (TEWL) Value | Neck Skin |
| group | used | (g/m²h) | pH Value | (g/m²h) | pH Value | (g/m²h) | pH Value |
| 1 | IE 1 | 11.79 ± 1.21 | 5.5 ± 0.2 | 11.62 ± 1.31 | 5.0 ± 0.1 | 11.59 ± 1.71 | 5.1 ± 0.3 |
| | Blank | | | 11.49 ± 1.21 | 5.2 ± 0.2 | 11.79 ± 1.21 | 5.2 ± 0.1 |
| 2 | IE 2 | 11.81 ± 1.67 | 5.0 ± 0.3 | 11.67 ± 2.13 | 4.9 ± 0.3 | 11.92 ± 1.71 | 4.9 ± 0.3 |
| | Blank | | | 11.49 ± 1.21 | 4.9 ± 0.1 | 11.62 ± 2.05 | 4.9 ± 0.1 |
| 3 | IE 3 | 12.26 ± 1.95 | 4.7 ± 0.4 | 12.35 ± 1.45 | 4.3 ± 0.2 | 12.82 ± 0.95 | 4.4 ± 0.3 |
| | Blank | | | 12.19 ± 1.67 | 4.6 ± 0.1 | 12.16 ± 1.37 | 4.6 ± 0.1 |
| 4 | IE 4 | 10.25 ± 1.66 | 5.0 ± 0.3 | 10.24 ± 1.63 | 5.0 ± 0.3 | 10.25 ± 0.96 | 4.7 ± 0.2 |
| | Blank | | | 10.82 ± 1.27 | 5.0 ± 0.2 | 10.75 ± 1.43 | 4.9 ± 0.3 |
| 5 | IE 5 | 11.05 ± 0.57 | 5.1 ± 0.2 | 11.09 ± 1.18 | 5.1 ± 0.3 | 11.31 ± 0.73 | 5.1 ± 0.1 |
| | Blank | | | 11.19 ± 1.21 | 5.2 ± 0.1 | 11.15 ± 1.71 | 5.2 ± 0.2 |
| 6 | IE 6 | 9.95 ± 0.57 | 5.4 ± 0.2 | 10.84 ± 1.07 | 5.2 ± 0.3 | 10.95 ± 1.27 | 5.1 ± 0.3 |
| | Blank | | | 9.85 ± 1.57 | 5.4 ± 0.2 | 10.09 ± 1.03 | 5.5 ± 0.3 |
| 7 | IE 7 | 12.35 ± 0.85 | 4.5 ± 0.2 | 11.96 ± 1.83 | 4.6 ± 0.3 | 12.95 ± 0.35 | 4.7 ± 0.3 |
| | Blank | | | 12.01 ± 1.85 | 4.6 ± 0.4 | 12.24 ± 0.74 | 4.9 ± 0.1 |
| 8 | IE 8 | 12.95 ± 1.22 | 5.1 ± 0.2 | 12.83 ± 0.42 | 5.1 ± 0.2 | 12.73 ± 1.62 | 5.0 ± 0.3 |
| | Blank | | | 12.79 ± 0.32 | 5.2 ± 0.3 | 12.75 ± 1.18 | 5.1 ± 0.3 |
| 9 | CE 1 | 11.05 ± 1.32 | 4.9 ± 0.3 | 12.91 ± 1.27 | 4.7 ± 0.4 | 12.64 ± 0.73 | 4.8 ± 0.3 |
| | Blank | | | 11.05 ± 1.32 | 4.9 ± 0.2 | 11.05 ± 1.32 | 5.0 ± 0.3 |
| 10 | CE 2 | 10.41 ± 0.96 | 5.1 ± 0.3 | 12.29 ± 1.53 | 4.9 ± 0.3 | 12.36 ± 0.93 | 4.8 ± 0.4 |
| | Blank | | | 10.16 ± 1.19 | 5.1 ± 0.2 | 10.21 ± 0.59 | 5.0 ± 0.3 |

Transepidermal water loss (TEWL) is an indicator used to monitor and assess the barrier function of the stratum corneum of the skin. Daily cleaning products can easily remove the skin's naturally secreted lipids, which to some extent reduces the skin's natural ability to retain moisture through its lipid barrier. The higher the TEWL value, the more water is lost through the skin per unit time, indicating that the skin tends to be drier and more keratinized; testing the pH value of human skin can help determine the ability of the tested area to return to the normal pH level of the body's skin after using daily cleaning products. Given the relatively small sample size, pH testing is more meaningful and useful for reference compared to sebum testing, which shows large differences in values between genders and among individuals.

The above test results indicate that the impact on the pH value of the neck skin of subjects using the foam-rich instant cleaning block samples in IE 1-8, as well as CE 1 and 2, is minimal during the washing process. However, the subjects using CE 1 and 2 exhibited a slight decrease in neck skin pH value; regarding the changes in transepidermal water loss (TEWL) values after using the foam-rich instant cleaning block samples in IE 1-8 and CE 1 and 2, it was observed that the TEWL values for subjects using the foam-rich instant cleaning block samples in IE 1-8 did not change significantly. In contrast, the TEWL values for subjects using CE 1 and 2 increased. This increase may be due to the relatively higher alkalinity of CE 1 and 2, which could impair the subjects' neck skin's ability to return to its normal pH level and cause some skin dryness, affecting the natural lipid barrier function of the skin in retaining moisture. The foam-rich instant cleaning block samples in IE 1-8, containing a high proportion of Sodium Lauroyl Glutamate, have the advantage of having a lower impact on the skin's natural state.

Based on feedback collected from the participants, it is generally perceived that there is a deficiency in the foam richness when using the CE 1 and 2. Participants were more satisfied with the foam generation capability and content of the IE 1-8, and there is no noticeable slippery feeling after washing, which makes it more user-friendly for male users.

The above IE are specific implementation methods of the present invention intended to facilitate understanding of its principles. However, the implementation method of the present invention is not limited to the above IE. Additionally, any modifications, equivalent replacements, improvements, etc., made within the spirit and principles of the present invention should be encompassed within the scope of the invention's protection.

What is claimed is:

1. A foam-rich instant cleaning block, characterized by: formulated by weight parts as follows:
Alkaline salt 15-25 parts; pH buffer regulator 15-20 parts; sodium lauryl sulfate 5-8 parts;
sodium lauroyl glutamate 28-30 parts; filler: 20-25 parts; sodium carboxymethyl cellulose 0.3-0.5 parts; preservative 1-2.5 parts; fragrance 0-0.5 parts; pigment 0-0.1 parts;
The alkaline salt referred to are one or more of sodium carbonate, potassium carbonate, sodium bicarbonate, or potassium bicarbonate;
The pH buffer regulators referred to are one or more of citric acid, tartaric acid, or sodium citrate;
The fillers referred to are one or more of magnesium sulfate, sodium sulfate, or urea;
The cleaning block described is a solid block composition with uniform distribution of the components, having a density of 1.1-1.25 g/cm³ and compressive strength of 130-180 N/cm².

2. A method for manufacturing a foam-rich instant cleansing block as described in claim 1, characterized by:
(1) Add powdered alkaline salt, sodium lauryl sulfate, sodium lauroyl glutamate, filler, sodium carboxymethyl cellulose, preservative, fragrance, and pigment in specified proportions to a dispersing machine; Stir thoroughly at room temperature until well dispersed, forming powdered mixture A;
(2) Add the powdered pH buffer regulator in proportion into the grinder, stir and crush at room temperature, sieve to obtain pH buffer regulator of 80-100 mesh;
(3) Mix the pH buffer regulator of 80-100 mesh into the powdered mixture A, blend them together at a stirring speed of 1000-1500 r/min for 30-60 seconds, repeat this process 2-3 times to produce powdered mixture B;
(4) Fill the powdered mixture B into the mold, use a forging press machine to compress it at a pressure of 5-15 kg/cm² of surface area; Maintain the pressure for 1-5 seconds before demolding to produce preformed blocks;
(5) Transfer the preformed blocks to a drying room, where they are dried under conditions of 25-28° C. temperature and 30%-40% relative humidity (RH) for 24 hours to produce the foam-rich instant cleaning blocks as described.

3. A method of packaging the foam-rich instant cleaning block described in claim 1, characterized by the following steps: Forming the cleaning blocks into block shapes and individually storing them in three-sided sealed bags or aluminum-plastic blister packaging.

4. A method for using the foaming instant soluble cleaning blocks as claimed in claim 1 for non-therapeutic purposes, characterized by the following steps:
(1) Dissolve the cleaning blocks in water to form a cleaning agent, using a weight percentage ranging from 8% to 15%;
(2) Pump out the cleaning agent from the container directly or through a foaming pump head after agitation or shaking.
